(19) United States
(12) Patent Application Publication
(10) Pub. No.: US 2022/0412649 A1
(43) Pub. Date: Dec. 29, 2022

(54) METHOD FOR THE SEPARATION AND LIQUEFACTION OF METHANE AND CARBON DIOXIDE WITH REMOVAL OF THE AIR IMPURITIES PRESENT IN THE METHANE

(71) Applicant: L'Air Liquide Société Anonyme pour l'Etude et l'Exploitation des Procédés Georges Claude, Paris (FR)

(72) Inventor: Jorge Ernesto TOVAR RAMOS, Cachan (FR)

(21) Appl. No.: 17/835,732

(22) Filed: Jun. 8, 2022

(30) Foreign Application Priority Data
Jun. 9, 2021 (FR) 2106087

(51) Int. Cl. F25J 3/02

(52) U.S. Cl. CPC F25J 3/0219; F25J 3/0233; F25J 3/0266; F25J 2200/30; F25J 2210/04; F25J 2205/02; F25J 2210/66; F25J 2215/60; F25J 2215/80; F25J 2220/62; F25J 2245/02; F25J 2270/80

(57) ABSTRACT

A combined plant for cryogenic separation and liquefaction of methane and carbon dioxide in a biogas stream, including a mixing means, a compressor, a first exchanger, a distillation column, a second exchanger, a separating means, an expanding means, and a separator vessel. Wherein, the mixing means is configured such that the recycle gas is the overhead vapour stream, and the first exchanger and the expanding means are combined.

### CROSS REFERENCE TO RELATED APPLICATIONS

This application claims the benefit of priority under 35 U.S.C. § 119 (a) and (b) to French Patent Application No. 2106087, filed Jun. 9, 2021, the entire contents of which are incorporated herein by reference.

### BACKGROUND

The present invention relates to a facility and a process for producing liquid methane and liquid carbon dioxide from a biogas stream.

Biogas is the gas produced during the degradation of organic matter in the absence of oxygen (anaerobic fermentation), also known as methanization. This may be natural degradation—it is thus observed in marshland or in household waste landfills—but the production of biogas may also result from the methanization of waste in a dedicated reactor referred to as a methanizer or digester.

By virtue of its main constituents—methane and carbon dioxide—biogas is a powerful greenhouse gas; at the same time, it also constitutes a source of renewable energy which is appreciable in the context of the increasing scarcity of fossil fuels.

Biogas predominantly contains methane (CH₄) and carbon dioxide (CO₂), in proportions which can vary according to the way in which it is obtained, but also contains, in smaller proportions, water, nitrogen, hydrogen sulfide, oxygen, and also other organic compounds, in the form of traces.

Depending on the organic matter which has undergone decomposition, and on the techniques used, the proportions of the components differ; on average, however, biogas comprises, on a dry gas basis, from 30% to 75% of methane, from 15% to 60% of CO₂, from 0% to 15% of nitrogen, from 0% to 5% of oxygen and trace compounds.

After a step of pretreating these contaminants, the biogas can be used as is in order to supply a boiler or a cogeneration unit, or else purified in order to obtain a gas which meets the specifications for injection into the natural gas network (e.g.: 3% CO₂ max).

In numerous regions of Europe and throughout the world, the natural gas network is not always accessible close to the areas of production of fermentable waste. Furthermore, while there is no need for heat on the biogas production site, depending on the purchase price of electricity, the cogeneration does not always have a sufficient output to render profitable the major investment in a digestion unit. It is then advantageous in these two cases to transport the biogas to a distribution or consumption point. The liquefaction of biogas after purification would make it possible to transport biomethane at a lower cost. According to the regulations in certain geographic zones, it is forbidden to release CH₄ into the environment: this adds an additional constraint and restricts the choice of biogas separation processes to highly effective methods.

Today, biogas purification processes are mainly based on absorption, permeation or adsorption techniques. These systems then require the addition of a supplementary module in order to obtain biomethane in the liquid form. Moreover, in the majority of cases, the content of CO₂ in the biogas at the end of this purification step is still too high to supply such liquefaction systems.

A system of cryotrapping based on the principles of reversible exchangers has been proposed. The system is based on the solidification of the CO₂ present in the biogas on a cold surface (trapping), followed by a step of sublimation or liquefaction of the CO₂ using a hot source. For a continuous production of biomethane, is then necessary to work with several exchangers in parallel. Their solution makes it possible to separate and liquefy the methane and the CO₂ into separate steps, but it is not possible to recover the cold used in the solidification of the CO₂.

Starting from there, one problem that arises is that of providing a method of separating and liquefying methane and CO₂ from biogas with a minimum loss of methane and using a minimum of operations.

### SUMMARY

One solution of the present invention is a combined facility for cryogenic separation and liquefaction of methane and carbon dioxide in a biogas stream, comprising:
a means M1 for mixing the biogas 1 with a recycle gas R,
a compressor for compressing the mixture to the distillation pressure,
an exchanger E01 for cooling the compressed mixture,
a distillation column K01 supplied with the cooled mixture and making it possible to produce a methane-enriched stream at the top of the column and a CO₂-enriched liquid at the bottom of the column,
an exchanger E02 for liquefying the methane-enriched stream produced at the top of the column K01,
a separator vessel V04 for receiving the methane-enriched liquid 2 and for recovering an overhead vapour and liquid methane 3,
a means for sending the liquid methane to the top of the column K01,
a distillation column K02 supplied with the overhead vapour obtained from the separator vessel V04 and making it possible to produce a stream enriched in impurities at the top of the column K02 and a methane-enriched liquid 4 at the bottom of the column K02,
a means M3 for expanding and heating the CO₂-enriched liquid recovered at the bottom of the column K01 and for recovering the cold from the CO₂-enriched liquid, and
a separator vessel V01 for receiving the CO₂-enriched stream from the means M3 and for recovering an overhead vapour and CO₂-enriched liquid 5,

with
the means M1 such that the recycle gas R corresponds to the overhead vapour recovered at the outlet of the separator vessel V01, and
the exchanger E01 and the means M3 being combined.

Depending on the case, the facility according to the invention may have one or more of the following characteristics:
the facility comprises a means for heating the CO₂-enriched liquid 5 leaving the separator vessel V01 and a separator vessel V03 for receiving the heated liquid CO₂ and for recovering an overhead vapour and liquid CO₂,
the facility comprises, upstream of the means M1, means for drying and desulfurization of the biogas,
the facility comprises, upstream of the means M1, a means C01 for compressing the biogas to the pressure of the recycle gas R,
the facility comprises, upstream of the means M1, a means C01E and/or C02E for cooling the biogas to ambient temperature,
the exchanger E02 is within a closed refrigeration circuit,
the refrigeration circuit uses methane as refrigerant fluid,
the distillation column K01 comprises heating at the bottom of the column.

The present invention also relates to a combined process of cryogenic separation and liquefaction of methane and carbon dioxide within a biogas stream, using the facility as defined previously, and comprising:
a) a step of mixing the biogas 1 with a recycle gas R,
b) a step of compressing the mixture to the distillation pressure,
c) a step of cooling the compressed mixture in the exchanger E01,
d) a step of distilling the cooled mixture in the distillation column K01 so as to produce a methane-enriched stream at the top of the column and a CO₂-enriched liquid at the bottom of the column,
e) a step of liquefying the methane-enriched stream produced at the top of the column in the exchanger E02,
f) a step of separating the methane-enriched liquid 2 resulting from the exchanger E02 in the separator vessel V04 into liquid methane 3 and overhead vapour,
g) a step of sending the liquid methane 3 to the top of the distillation column K01,
h) a step of distilling the overhead vapour obtained from the separator vessel V04 in the distillation column K02 so as to produce a stream enriched in impurities at the top of the column K02 and a methane-enriched liquid 4 at the bottom of the column K02,
i) a step of expanding and heating the CO₂-enriched liquid recovered at the bottom of the column in the exchanger E01, and of recovering the cold from the CO₂-enriched liquid,
j) a step of separating the CO₂-enriched stream resulting from the exchanger E01 in the separator vessel V01 into liquid CO₂ 5 and overhead vapour,

with the recycle gas R corresponding to the overhead vapour produced in step a).

Depending on the case, the process according to the invention may have one or more of the characteristics below:
the process comprises a step of heating the CO₂-enriched liquid 5 leaving the separator vessel V01 and a step of separating the heated CO₂-enriched liquid in the separator vessel V03 into overhead vapour and liquid CO₂;
the process comprises, upstream of step a), drying and desulfurization steps;
the process comprises, upstream of step a), a step of compressing the biogas to the pressure of the recycle gas R;
the process comprises, upstream of step a), a step of cooling the biogas to ambient temperature;
the process comprises, downstream of step j), a step of heating the liquid CO₂ so as to vaporize it;
step e) is performed by cooling the produced methane by means of a refrigerant fluid;
in step b), the mixture is compressed to a pressure of between 7 and 46 bar.

The process according to the invention makes it possible to separate and liquefy the products of the biogas in a single combined distillation/liquefaction operation. The operating conditions of the products at the inlet and outlet of the column and in the recycle section have been calculated to prevent the formation of solid CO₂.

The thermal integration between the streams of the separation section and those of the refrigeration cycle enable the recovery of the cold used in the liquefaction of the CO₂ and in the recycling of the liquid methane. It is possible to completely or partly recover the energy used in the liquefaction of the CO₂ if this CO₂ is not desired as a product or when it can be used in the gaseous state.

### BRIEF DESCRIPTION OF THE DRAWING

For a further understanding of the nature and objects for the present invention, reference should be made to the following detailed description, taken in conjunction with the accompanying drawings, in which like elements are given the same or analogous reference numbers and wherein:

FIG. 1 illustrates a refrigeration circuit in accordance with one embodiment of the present invention

### DETAILED DESCRIPTION OF PREFERRED EMBODIMENTS

The pretreated biogas 1 (pretreated by drying, desulfurization) is introduced into the process at atmospheric pressure and temperature, it is compressed a first time in a compressor C01, to the pressure of the recycle circuit (around 8 bar). After compression, it is cooled in C01E to ambient temperature with CW (=Cooling Water) or air.

Next, it is mixed with a recycle stream R, the mixture is compressed in a compressor CO₂, to the pressure of the distillation column (around 15 bar) or more depending on the requirements of the downstream exchanger E01 and it is cooled to ambient temperature in C02E, with CW or air.

Preferably, C01E and C02E are shell and tube exchangers (coolers of the compressors)

The mixture of biogas—recycle stream R is sent to the exchanger E01. The main purpose of this exchanger is to cool the mixture in preparation for the distillation.

The mixture can then be expanded or supplied directly to the column where it will be used as reboiler.

If there is no heat source at the bottom of the column, it is necessary to inject the mixture into the bottom to ensure the circulation of vapour from the bottom. If there is a heat source in the bottom of the column (reboiler), the mixture is introduced higher up in the column.

The distillation column K01 separates the methane from the carbon dioxide. The feed for the column is the biogas+recycle stream R mixture. This feed acts as main reboiler; an additional source of heat may also be used (for example an electrical resistance heater, vapour or a portion of the hot biogas in indirect contact). The product at the top of the column is pure CH₄ in the vapour state. The bottom product is a liquid rich in CO₂, containing around 95%-98%.

The methane at the top of the column is liquefied in the exchanger E02, against a fluid from a closed refrigeration circuit. The methane-enriched liquid 2 resulting from the exchanger E02 is separated in the separator vessel V04 into liquid methane and overhead vapour. Typically, the overhead vapour will comprise methane, oxygen and nitrogen. The liquid methane 3 from the separator vessel V04 is used as column recycle and is fed back into the top of the distillation column K01. The overhead vapour obtained from the separator vessel V04 is distilled in the distillation column K02 so as to produce a stream enriched in impurities (oxygen and nitrogen) at the top of the column K02 and a methane-enriched liquid 4 at the bottom of the column K02. Preferably, the overhead vapour from the separator vessel V04 is introduced into the distillation column at an intermediate stage of the column.

The CO₂-enriched liquid recovered at the bottom of the column is expanded and heated in the exchanger E01 countercurrent to the biogas—recycle stream R mixture.

The CO₂-enriched stream from the exchanger E01 is sent to the separator vessel V01.

The overhead vapour of the vessel V01 is reheated in the exchanger E01 and then mixed with the biogas. It corresponds to the stream previously named “recycle stream R”.

The liquid from the bottom of the vessel V01 is the pure CO₂ 5. This can, depending on the requirements, leave the process as product or be reheated in the exchanger E01 and in another exchanger E03 of the refrigeration circuit in order to be completely vaporized before leaving the cycle. Note that the pure CO₂ could alternatively be reheated and vaporised in the exchanger E03 without passing through the exchanger E01.

Preferentially, the pure liquid CO₂ (CO₂-enriched liquid) leaving the separator vessel V01 will be heated in the exchanger E01 and then introduced into a separator vessel V03 to be separated into an overhead vapour and liquid CO₂ which is even purer than that leaving the separator vessel V01.

The exchanger E01 thus uses, as sources of cold: the CO₂-enriched liquid recovered at the bottom of the column, the overhead vapour V01 called the “recycle stream R” at the outlet of the exchanger E01, and optionally the pure liquid CO₂ recovered at the bottom of the vessel V01 in the case where its vaporization is desired or if it is desired to purify it even further in a separator vessel V03.

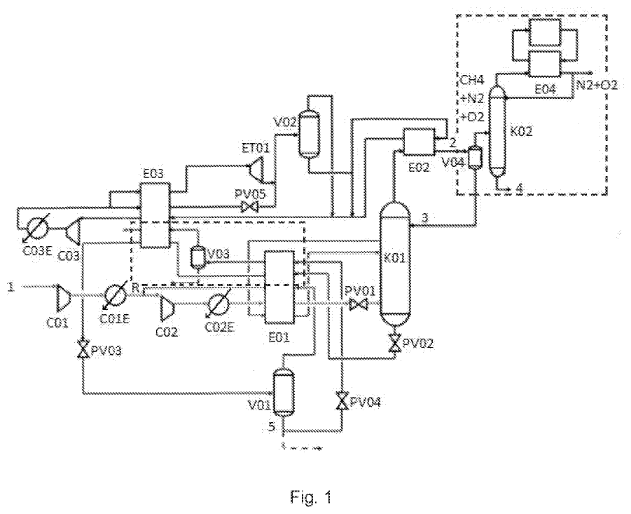

The process requires an input of refrigeration power in order to operate. This input of cold is represented in FIG. 1 by the refrigeration circuit. It is composed of:
a compressor C03 with cooler C03E;
an exchanger E03 which cools the compressed fluid using the recycled refrigerant fluid and the cold recovered from the separation cycle;
a turbine ET01 and a JT valve PV05, for the expansion of the refrigerant fluid and production of cold;
a separator vessel V02 for separating the vapour and liquid phases of the refrigerant fluid;
an exchanger E02 which uses the liquid phase of the refrigerant fluid to liquefy the biomethane at the top of the distillation column.
The refrigerant fluid used in the scheme is CH₄, but it can be replaced with other fluids such as N₂, N₂+H₂, inter alia.

This refrigeration cycle can be replaced by other sources of cold (depending on the amount of liquid biomethane to be produced). By way of example but not exclusively:
using a source of liquid nitrogen;
by a Brayton cycle process.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A combined facility for the cryogenic separation and liquefaction of methane and carbon dioxide in a biogas stream, comprising:
a mixing means for mixing a biogas stream with a recycle gas stream, thereby producing a mixed biogas stream,
a compressor for compressing the mixed biogas stream to a pressure suitable for distillation, thereby producing a compressed stream,
a first exchanger for cooling the compressed stream,
a distillation column, comprising a top and a bottom, and configured to be supplied with the cooled mixture and configured to produce a methane-enriched stream at the top and a first CO₂-enriched liquid stream at the bottom,
a second exchanger for liquefying the methane-enriched stream, thereby producing a liquefied methane stream,
a separator vessel for receiving the liquefied methane stream and for recovering an overhead vapour stream and liquid methane stream,
a pumping means for sending the liquid methane to the top,
a distillation column supplied with the overhead vapour stream and configured to produce an impurity enriched stream at the top and a methane-enriched liquid stream at the bottom,
an expanding means for expanding and heating the first CO₂-enriched liquid stream and for recovering the cold from the first CO₂-enriched liquid stream, thereby producing a first heated CO₂-enriched stream, and
a first separator vessel for receiving the first heated CO₂-enriched stream and for recovering a first overhead vapour stream and a second CO₂-enriched liquid stream,
wherein
the mixing means is configured such that the recycle gas stream is the overhead vapour, and
the first exchanger and the expanding means are combined.

2. The facility according to claim 1, further comprising a heating means for heating the second CO₂-enriched liquid stream, thereby producing a second heated CO₂-enriched stream, and a second separator vessel for receiving second heated CO₂-enriched stream and for recovering a second overhead vapour stream and liquid CO₂ stream.

3. The facility according to claim 1, further comprising, upstream of the mixing means, a drying means for drying and desulfurization of the biogas stream.

4. The facility according to claim 1, further comprising, upstream of the mixing means, a compressing means for compressing the biogas stream to the pressure of the recycle gas stream.

5. The facility according to claim 1, further comprising, upstream of the mixing means, a cooling means for cooling the biogas stream to ambient temperature.

6. The facility according to claim 1, wherein the second exchanger is within a closed refrigeration circuit.

7. The facility according to claim 6, wherein the refrigeration circuit uses methane as refrigerant fluid.

8. The facility according to claim 1, wherein the distillation column comprises heating at the bottom.

9. A combined process for the cryogenic separation and liquefaction of methane and carbon dioxide in a biogas stream, using the facility as defined in claim 1, the process comprising:
a) mixing the biogas stream with a recycle gas stream,
b) compressing the mixed biogas stream to the distillation pressure,
c) cooling the compressed mixed biogas stream in the first exchanger,
d) distilling the cooled stream in the distillation column thereby producing the methane-enriched stream at the top and the first CO₂-enriched liquid stream at the bottom,
e) liquefying the methane-enriched stream in the second exchanger,
f) separating the liquefied methane stream in the separator vessel into the liquid methane stream and the overhead vapour stream,
g) sending the liquid methane stream to the top of the distillation column,
h) distilling the overhead vapour stream in the distillation column K02 thereby producing an impurity rich stream at the top and a methane-enriched liquid stream at the bottom,
i) expanding and heating the first CO₂-enriched liquid stream, and of recovering the cold from the first CO₂-enriched liquid stream, and
j) a step of separating the first CO₂-enriched stream in the separator vessel into the liquid CO₂ stream and the overhead vapour stream,
with the recycle gas stream corresponding to the overhead vapour stream produced in step a).

10. The process according to claim 9, further comprising heating the first CO₂-enriched liquid and a step of separating the first heated CO₂-enriched liquid in the second separator vessel into the overhead vapour stream and the second liquid CO₂ stream.

11. The process according to claim 9, further comprising, upstream of step a), steps of drying and of desulfurization of the biogas stream.

12. The process according to claim 9, further comprising, upstream of step a), a step of compressing the biogas stream to the pressure of the recycle gas stream.

13. The process according to claim 9, further comprising, upstream of step a), a step of cooling the biogas stream to ambient temperature.

14. The process according to claim 9, further comprising, downstream of step j), a step of heating and vaporizing the liquid CO₂ stream

15. The process according to claim 9, step e) is performed by cooling the methane stream by means of a refrigerant fluid.

16. The process according to claim 9, in step b), the mixed biogas stream is compressed to a pressure of between 7 and 46 bar.
